(19) United States
(12) Patent Application Publication
(10) Pub. No.: US 2023/0411042 A1
(43) Pub. Date: Dec. 21, 2023

(54) ELECTRICAL CONNECTING ASSEMBLY

(71) Applicant: LOTES CO., LTD, Keelung (TW)

(72) Inventors: Zhi Jun Feng, Keelung (TW); Ming Jiang, Keelung (TW)

(21) Appl. No.: 18/205,606

(22) Filed: Jun. 5, 2023

(30) Foreign Application Priority Data
Jun. 9, 2022 (CN) 202210649697.X

(51) Int. Cl. H01B 11/04; H01B 7/02; H01B 11/10

(52) U.S. Cl. CPC H01B 11/04; H01B 11/10; H01B 7/0216

(57) ABSTRACT

An electrical connecting assembly includes a first connecting member, a second connecting member, and two pairs of differential conducting wires connected between the first connecting member and the second connecting member and provided to be adjacent to each other. Polarity arrangements of the first cable core and the second cable core of one pair of differential conducting wires at a first end thereof and at a second end thereof are opposite to each other, and polarity arrangements of the first cable core and the second cable core of the other pair of differential conducting wires at a first end thereof and at a second end thereof are identical to each other. The invention may reduce the remote crosstalk of the electrical connecting assembly, and performance of the remote crosstalk characteristics thereof in high frequency is good.

### CROSS-REFERENCE TO RELATED PATENT APPLICATION

This non-provisional application claims priority to and the benefit of, pursuant to 35 U.S.C. § 119(a), patent application Serial No. CN202210649697.X filed in China on Jun. 9, 2022. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connecting assembly, and particularly to an electrical connecting assembly improving remote crosstalk.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A conventional electrical connecting system includes two connectors transmitting signals to each other. When the signals are transmitted from one connector to the other connector, the transmission path will be affected by far end crosstalk (FEXT) of the surrounding interference sources, and with the signals being transmitted, the FEXT will gradually accumulate and increase. In order to reduce the far end interference to the connectors, the industry generally focuses on the terminal structure of the connectors. For example:

For two pairs of differential terminals provided to be adjacent to each other in a connector, the positive signal terminal and the negative signal terminal in one pair of the differential terminals are provided to cross each other, allowing the relative physical locations of the positive signal terminal and the negative signal terminal to be switched to facilitate polarity reversal, and the other pair of the differential terminals do not cross each other, such that by the polarity reversal, the FEXT of the former is canceled by the FEXT of the later with a different phase, and after accumulation, the overall FEXT is reduced. However, to avoid contacting, the positive signal terminal and the negative signal terminal have the space separating from each other in the width direction, and require to additional increase the space separating from each other in the height direction to facilitate the crossing, thus requiring a larger space to provide the positive signal terminal and the negative signal terminal crossing each other, thereby affecting the internal space arrangement of the connector, and the crossing provision also increases the forming difficulties of the positive signal terminal and the negative signal terminal. Meanwhile, the transmission path of the pair of the differential terminals crossing each other will be longer than the transmission path of the other pair of the differential terminals not crossing each other, and to reduce the transmission time difference of the two pairs of the differential terminals, the other pair of the differential terminals not crossing each other must be additional provided with bending portions to extend the transmission path thereof, thus compensating the transmission time delay of the two pairs of the differential terminals. However, this also increases the forming difficulties of the other pair of the differential terminals.

Alternatively, the structures of the differential terminals may be used to increase the coupling effect of a pair of the differential terminals, thus adjusting the self-inductance and mutual inductance ratio and the self-capacitance and mutual capacitance ratio of the differential terminals, thereby improving the FEXT by adjusting the two ratios. The structural designs will have greater effects to the impedances of the differential terminals, and increase the design difficulties and forming difficulties of the connector.

Therefore, a heretofore unaddressed need to design an electrical connecting assembly exists in the art to address the aforementioned deficiencies and inadequacies.

### SUMMARY

The present invention is directed to an electrical connecting assembly, in which polarity arrangements of the first cable core and the second cable core of one pair at the first ends thereof and at the second ends thereof are opposite to each other; and polarity arrangements of the first cable core and the second cable core of the other pair at the first ends thereof and at the second ends thereof are identical to each other, such that the FEXT at the first ends thereof and at the second ends thereof are canceled by each other, thus reducing the FEXT of the electrical connecting assembly, and in particular, the FEXT characteristics in high frequency thereof will be in excellent performance. Meanwhile, the flexibility characteristics of the first cable core and the second cable core may be utilized to facilitate polarity exchange, thus greatly simplifying the manufacturing process, without affecting the design difficulties and forming difficulties of the first connecting member and the second connecting member.

To achieve the foregoing objective, the present invention adopts the following technical solutions. An electrical connecting assembly includes: a first connecting member; a second connecting member; and two cable sets provided to be adjacent to each other, comprising a first cable set and a second cable set, connected between the first connecting member and the second connecting member, wherein each of the cable sets comprises a first cable core and a second cable core provided in a pair and configured to transmit differential signals, and a shielding layer surrounding outer peripheries of the first cable core and the second cable core, the first cable core, the second cable core and the shielding layer are electrically isolated from one another, the first cable core is configured to transmit signals in a first polarity, the second cable core is configured to transmit signals in a second polarity, and the first polarity and the second polarity are opposite to each other. For each of the cable sets, a first end of the first cable core and a first end of the second cable core are provided to be adjacent to each other and are both connected to the first connecting member, and a second end of the first cable core and a second end of the second cable core are provided to be adjacent to each other and are both connected to the second connecting member. Relative physical locations of the first cable core and the second cable core of the first cable set are switched in a transmission path thereof, and polarity arrangements of the first cable core and the second cable core of the first cable set at the first ends thereof and at the second ends thereof are opposite to each other; and polarity arrangements of the first cable core and the second cable core of the second cable set at the first ends thereof and at the second ends thereof are identical to each other. The polarity arrangements of the first cable cores and the second cable cores of the two cable sets at the first ends thereof are sequentially the first polarity, the second polarity, the first polarity and the second polarity, and the polarity arrangements of the first cable cores and the second cable cores of the two cable sets at the second ends thereof are sequentially the second polarity, the first polarity, the first polarity and the second polarity.

In certain embodiments, the first cable set comprises at least one insulating material wrapping outside the first cable core and outside the second cable core, the first cable core and the second cable core are isolated by the insulating material and maintain a constant isolation distance therebetween, and the shielding layer is located at an outer side of the insulating material; and relative physical locations of the first cable core and the second cable core of the second cable set maintain unchanged in a transmission path thereof.

In certain embodiments, the first cable set is provided with a positioning portion, and the positioning portion is located on the first cable set at a location adjacent to the second end thereof, allowing an operation body to drive the positioning portion to twist the first cable set when the first end thereof is relatively fixed.

In certain embodiments, the first cable set comprises a first insulating material wrapping outside the first cable core and a second insulating material wrapping outside the second cable core, the first cable core and the first insulating material form a first conducting wire, the second cable core and the second insulating material form a second conducting wire, the shielding layer wraps outer sides of the first conducting wire and the second conducting wire, each of the first conducting wire and the second conducting wire is provided with an exposed portion at a location adjacent to the first end thereof or the second end thereof, the exposed portion is located outside the shielding layer, and the exposed portion of the first conducting wire and the exposed portion of the second conducting wire cross each other, such that the relative physical locations of the first cable core and the second cable core of the first cable set are switched.

In certain embodiments, the first connecting member is a circuit board, the circuit board has two pairs of differential signal channels configured to be connected to the two cable sets respectively, and each pair of the two pairs of differential signal channels comprises a first channel and a second channel; and relative physical locations of the first channel and the second channel of one pair of the two pairs of differential signal channels are switched in a transmission path thereof to switch polarity arrangements of the first channel and the second channel; and relative physical locations of the first channel and the second channel of the other pair of the two pairs of differential signal channels maintain unchanged in a transmission path thereof.

In certain embodiments, the first cable set is provided with at least one maintaining section and at least one twisting section, the relative physical locations of the first cable core and the second cable core of the first cable set in the maintaining section maintain unchanged, and the relative physical locations of the first cable core and the second cable core of the first cable set in the twisting section are switched.

To achieve the foregoing objective, the present invention adopts the following technical solutions. An electrical connecting assembly includes: a first connecting member; a second connecting member; and two pairs of differential conducting wires provided to be adjacent to each other, comprising a first pair of differential conducting wires and a second pair of differential conducting wires, connected between the first connecting member and the second connecting member, wherein each pair of the two pairs of differential conducting wires comprises a first cable core and a second cable core provided to be adjacent to each other, the first cable core is configured to transmit signals in a first polarity, the second cable core is configured to transmit signals in a second polarity, and the first polarity and the second polarity are opposite to each other. Polarity arrangements of the first cable core and the second cable core of the first pair of differential conducting wires at a first end thereof and at a second end thereof are opposite to each other; and wherein polarity arrangements of the first cable core and the second cable core of the second pair of differential conducting wires at a first end thereof and at a second end thereof are identical to each other.

In certain embodiments, relative physical locations of the first cable core and the second cable core of the second pair of differential conducting wires maintain unchanged in a transmission path thereof.

In certain embodiments, the first connecting member is a circuit board, the circuit board has two pairs of differential signal channels configured to be connected to the two pairs of differential conducting wires respectively, and each pair of the two pairs of differential signal channels comprises a first channel and a second channel respectively connected to the first cable core and the second cable core of a corresponding pair of the two pairs of differential conducting wires; and relative physical locations of the first channel and the second channel of one pair of the two pairs of differential signal channels are switched in a transmission path thereof to switch polarity arrangements of the first channel and the second channel; and relative physical locations of the first channel and the second channel of the other pair of the two pairs of differential signal channels maintain unchanged in a transmission path thereof.

In certain embodiments, the first pair of differential conducting wires is provided with a positioning portion, the positioning portion is located on the first pair of differential conducting wires at a location adjacent to the second end thereof, allowing an operation body to be fixed relatively at the first end thereof to drive the positioning portion to twist the first pair of differential conducting wires, such that polarity arrangements of the first cable core and the second cable core of the first pair of differential conducting wires at the first end thereof and at the second end thereof are opposite to each other, and the first cable core and the second core of the first pair of differential conducting wires extend in a straight line as a whole.

Compared with the related art, the electrical connecting assembly according to certain embodiments of the present invention has the following beneficial effects:

By switching the polarity arrangements of one pair of the first cable core and the second cable core at two ends thereof, while the polarity arrangements of the other pair of the first cable core and the second cable core at the two ends thereof remain unchanged, the FEXT generated from one of the cable sets at the first end thereof toward the other of the cable sets at the second end thereof and the FEXT generated from the one of the cable sets at the second end thereof toward the other of the cable sets the first end thereof are overlapped and thus are canceled, thereby reducing the overall FEXT in the overall path formed by the first connecting member, the cable sets and the second connecting member, thus reducing the mutual crosstalk between the first connecting member and the second connecting member, and performance of the remote crosstalk characteristics thereof in high frequency is good. The present invention utilizes the flexibility characteristics of the cable sets or the wires to easily facilitate polarity exchange, thus greatly simplifying the manufacturing process, and the implementation is achieved on the condition that the lengths of the different pairs of the first cable cores and the second cable cores are consistent, thus preventing from the issue that the transmission time difference of the differential signals in the different pairs is large. Meanwhile, the insulating material between the first cable core and the second cable core are utilized to facilitate the isolation of the first cable core and the second cable core, thus facilitating the switching of the relative physical locations of the first cable core and the second cable core without the need to additionally increase the space in the width or height directions, and without affecting the design difficulties and forming difficulties of the first connecting member and the second connecting member. Further, since each cable set of the electrical connecting assembly includes a shielding layer, which may shield the interference to the cable set from the outer environment, the FEXT does not overlap and increase in the regions of each cable set being wrapped by the shielding layer, thus further reducing the overall FEXT to the electrical connecting assembly.

Further, the technical solution and the technical effect according to certain embodiments of the present invention are not foreseeable by those skilled in the art, and the reasons are as follows:

Firstly, for a manufacturer that produces and designs the electrical connecting assembly, the cable sets or the wires of the electrical connecting assembly are generally purchased directly from other manufacturers that specialize in producing and designing the cable sets or the wires, thus performing the interconnection of the first connecting member and the second connecting member in a downstream stage of the manufacturing process of the electrical connecting assembly. Thus, when the manufacturer that produces and designs the electrical connecting assembly needs to optimize the FEXT characteristics of the electrical connecting assembly, it merely focuses on improving the first connecting member or the second connecting member being self-designed and produced, and often neglects to improve the cable sets or the wires that have been designed and produced by other manufacturers.

Secondly, in the design and manufacturing process of the electrical connecting assembly, the connecting of the first connecting member and the second connecting member by the cable sets or the wires is performed in the downstream stage of the design process and the downstream stage of the manufacturing process of the whole product. Specifically, in the design process, the technicians in the industry generally design firstly the corresponding structures of the first connecting member and the second connecting member, and when carrying out the simulation test, considering that there will be certain signal loss on the cable sets or the wires, the technicians will build the overall simulation model by adding the signal loss amount of the cable sets or the wires on the basis of the model of the first connecting member and the second connecting member, thus performing the characteristics simulation test. However, considering that the lengths and product characteristics of the cable sets or the wires have been ascertained, and the product characteristics have been tested and evaluated by other manufacturers, when the characteristics of the electrical connecting assembly do not meet the requirements, the technicians will continue to improve the first connecting member and the second connecting member. In the manufacturing process, the connecting step is generally at the last stage of the manufacturing process of the electrical connecting assembly, and the characteristics of the electrical connecting assembly must be ascertained to meet the standard before the production thereof. Thus, the technicians in the industry will not wait until the last stage of the manufacturing process to reduce the FEXT. Thus, for the cable sets and the wires, the technicians in the industry merely utilize them as the connecting instruments in design and usage, and when there is a need to improve the FEXT characteristics of the electrical connecting assembly, the technicians in the industry generally focus on the structural designs of the first connecting member and the second connecting member, and neglect to improve the cable sets or the wires that are used for the connection. This is the reason why the industry generally attempts to reduce the FEXT from the terminal structures and the shielding structures of the first connecting member or the second connecting member.

Thirdly, when utilizing the polarity exchange to reduce the FEXT, there is a need to provide of two corresponding mutual crossing transmission paths to perform location switching, and the mutual crossing state must remain unchanged. Thus, the technicians in the industry generally focus on providing two mutual crossing transmission paths on components that are rigid or fixed in their locations, for example, by providing the two mutual crossing transmission paths on the terminals or on an intermediate circuit board used to connect the first connecting member and the second connecting member, and providing the two transmission paths that maintain the mutual crossing state by utilizing the rigidity of the materials of the terminals or the features of the fixed locations of the signal channels on the intermediate circuit board. The technicians in the industry struggle to think of facilitating the polarity exchange on the cable sets or the wires that are flexible and in various shapes and forms.

In sum, the inventors of the present invention break through the conventional design ideas of the technicians in the industry, and innovatively optimize the cable sets or the wires, thus reducing the FEXT between the first connecting member and the second connecting member. In addition, based on the simulation results of the technical solution according to certain embodiments of the present invention, it can been seen that the technical solution according to certain embodiments of the present invention can significantly reduce the FEXT of the electrical connecting assembly.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective schematic view of an electrical connecting assembly according to a first embodiment of the present invention.

FIG. 2 is a plain view of an electrical connecting assembly according to the first embodiment of the present invention.

FIG. 3 is an enlarged view of a portion A in FIG. 2.

FIG. 4 is a partial perspective view of one first cable set according to the first embodiment of the present invention.

FIG. 5 is a perspective schematic view of a first cable set and a second cable set adjacent to each other according to the first embodiment of the present invention.

FIG. 6 is a simplified schematic view of an electrical connecting assembly according to the first embodiment of the present invention.

FIG. 7 is a partial plain view of an electrical connecting assembly according to a second embodiment of the present invention.

FIG. 8 is a perspective schematic view of a first cable set and a second cable set adjacent to each other according to a third embodiment of the present invention.

FIG. 9 is a perspective schematic view of the cable core in FIG. 8 after partially removing the protecting sleeve therefrom.

FIG. 10 is a partial perspective schematic view of a first cable set and a second cable set adjacent to each other according to a fourth embodiment of the present invention.

FIG. 11 is a perspective schematic view of two pairs of differential wires adjacent to each other in the electrical connecting assembly according to a fifth embodiment of the present invention.

FIG. 12 is a perspective schematic view of an electrical connecting assembly according to a sixth embodiment of the present invention.

FIG. 13 is a simulation test chart of the remote crosstalk characteristics of the electrical connecting assembly according to certain embodiments of the present invention prior to switching of the relative physical locations of the first cable core and the second cable core.

FIG. 14 is a simulation test chart of the remote crosstalk characteristics of the electrical connecting assembly according to certain embodiments of the present invention after switching of the relative physical locations of the first cable core and the second cable core.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

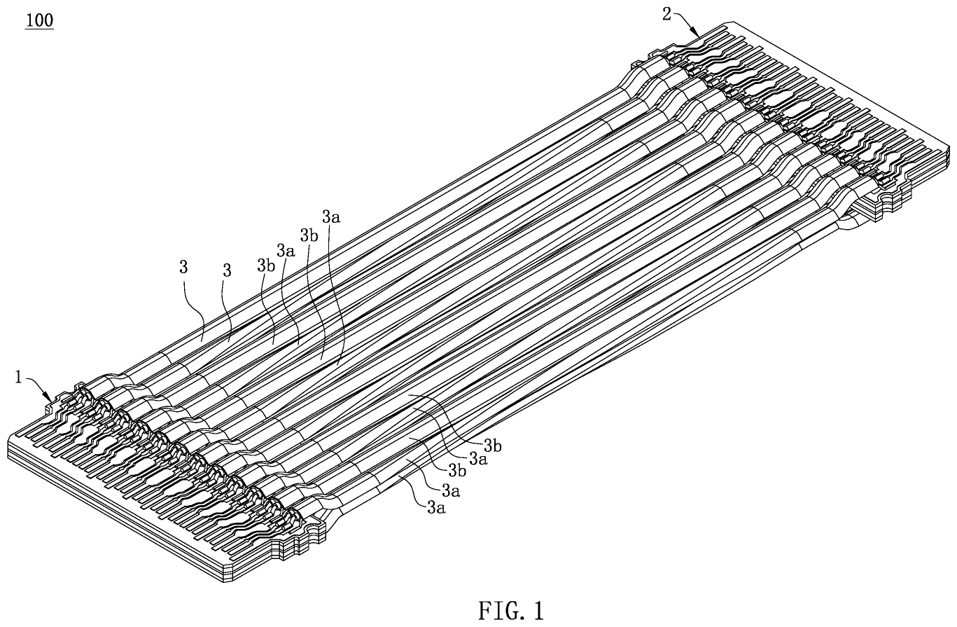

The description will be made as to the embodiments of the present invention in conjunction with the accompanying drawings in FIGS. 1-13. In accordance with the purposes of this invention, as embodied and broadly described herein, this invention, in one aspect, relates to an electrical connector.

Referring to FIG. 1 to FIG. 6, an electrical connecting assembly 100 according to a first embodiment of the present invention includes a first connecting member 1, a second connecting member 2 and a plurality of cable sets 3 connecting the first connecting member 1 and the second connecting member 2. In the present embodiment, the first connecting member 1 and the second connecting member 2 are both circuit boards. In other embodiments, the first connecting member 1 may be a connector or terminals or terminal modules 16 directly riveted on the cable sets 3, and similarly, the second connecting member 2 may be a connector or terminals or terminal modules 16 directly riveted on the cable sets 3, and the first connecting member 1 and the second connecting member 2 may be different, and are thus not hereinafter limited.

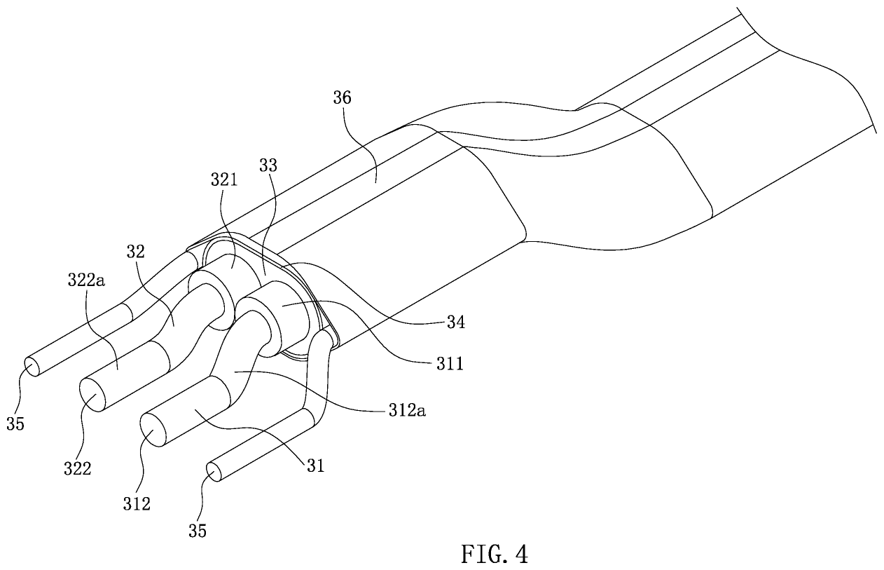

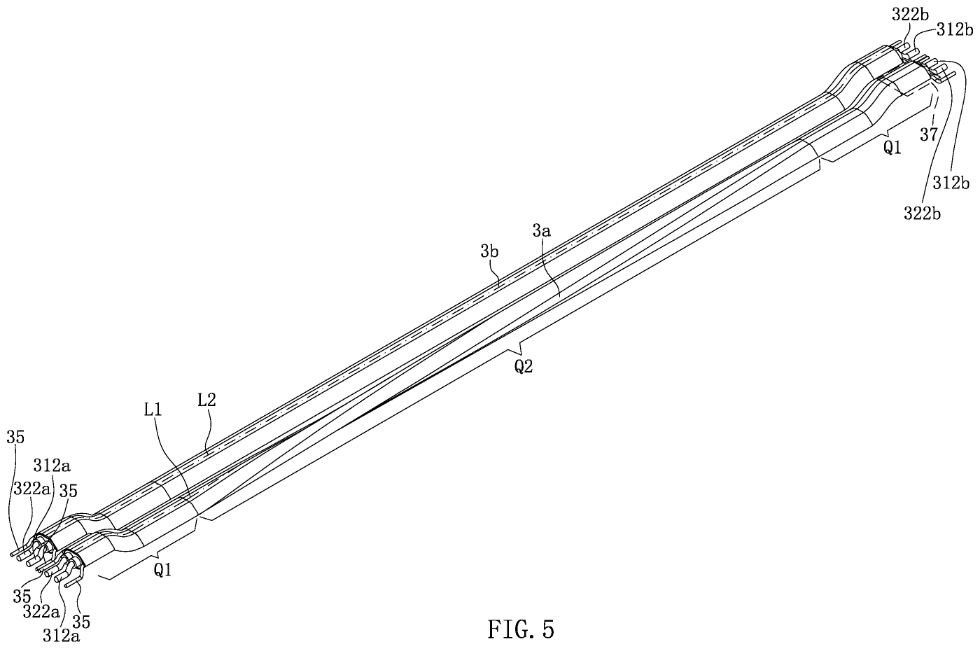

Referring to FIG. 1, FIG. 4 and FIG. 5, in the present embodiment, each cable set 3 includes a first conducting wire 31 and a second conducting wire 32 provided in a pair. The first conducting wire 31 includes a first insulating material 311 and a first cable core 312, and the second conducting wire 32 includes a second insulating material 321 and a second cable core 322. Each cable set 3 further includes a third insulating material 33 wrapping outside the first conducting wire 31 and outside the second conducting wire 32, a shielding layer 34 wrapping at an outer side of the third insulating material 33, two grounding wires 35 located at two sides thereof outside of the shielding layer 34, and a protecting sleeve 36 wrapping outside the shielding layer 34 and the two grounding wires In other embodiments, the cable sets 3 may be different from one another, and each cable set 3 may have no grounding wire 35, or have only one layer of insulating material to wrap the first cable core 312 and the second cable core 322 and separate them from each other without providing three layers of the insulating materials, or have no third insulating material 33, or be provided with more layers of the insulating material, without being limited thereto, as long as the first cable core 312, the second cable core 322 and the shielding layer 34 may be electrically isolated from one another. In the present embodiment, the cable sets 3 are provided to be independent and scattered from one another. In other embodiments, to better organize the electrical connecting assembly 100, the middle portions of the cable sets 3 may be simultaneously fixed in a fixing body, thus reducing the entwining among the cable sets 3.

Referring to FIG. 4 to FIG. 6, the cable sets 3 include a first cable set 3a and a second cable set 3b provided to be adjacent to each other. For each of the first cable set 3a and the second cable set 3b, the first cable core 312 and the second cable core 322 are used to transmit differential signals. The first cable core 312 is used to transmit the signals in a first polarity, the second cable core is used to transmit the signals in a second polarity, and the first polarity and the second polarity are opposite to each other. A first end 312a of the first cable core 312 and a first end 322a of the second cable core 322 are provided to be adjacent to each other and are both connected to the first connecting member 1, and a second end 312b of the first cable core 312 and a second end 322b of the second cable core 322 are provided to be adjacent to each other and are both connected to the second connecting member 2. The first conducting wire 31 and the second conducting wire 32 of the first cable set 3a are the first pair of the differential conducting wires, and the first conducting wire 31 and the second conducting wire 32 of the second cable set 3b are the second pair of the differential conducting wires. Relative physical locations of the first cable core 312 and the second cable core 322 of the first cable set 3a are switched in a transmission path thereof, and polarity arrangements of the first cable core 312 and the second cable core 322 at the first ends 312a, 322a thereof and at the second ends 312b, 322b thereof are opposite to each other. Further, polarity arrangements of the first cable core 312 and the second cable core 322 of the second cable set 3b at the first ends 312a, 322a thereof and at the second ends 312b, 322b thereof are identical to each other. Thus, the polarity arrangements of the first cable cores 312 and the second cable cores 322 of the two cable sets 3 at the first ends 312a, 322a thereof are sequentially the first polarity, the second polarity, the first polarity and the second polarity, and the polarity arrangements of the first cable cores 312 and the second cable cores 322 of the two cable sets 3 at the second ends 312b, 322b thereof are sequentially the second polarity, the first polarity, the first polarity and the second polarity. In the present embodiment, the cable sets 3 are arranged in two rows, and each rows include a plurality of first cable sets 3a and a plurality of second cable sets 3b arranged alternately and at intervals.

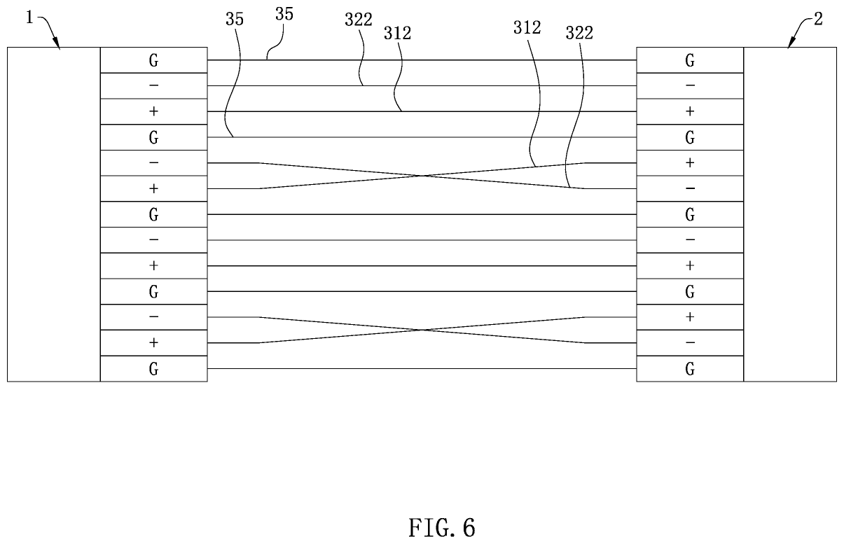

For better understanding purposes, an example is simplified and schematically shown in FIG. 6 using positive (+) as the first polarity and negative (−) as the second polarity. It is shown that, in the first cable set 3a, the polarity arrangements of the first cable core 312 and the second cable core 322 at the first ends 312a, 322a thereof are the first polarity (+) and the second polarity (−), and the polarity arrangements of the first cable core 312 and the second cable core 322 at the second ends 312b, 322b thereof are the second polarity (−) and the first polarity (+). Thus, the polarity arrangements of the first cable core 312 and the second cable core 322 of the first cable set 3a and the first cable core 312 and the second cable core 322 of the second cable set 3b at the first ends 312a, 322a thereof are sequentially the first polarity (+), the second polarity (−), the first polarity (+) and the second polarity (−), and the polarity arrangements of the first cable core 312 and the second cable core 322 of the first cable set 3a and the first cable core 312 and the second cable core 322 of the second cable set 3b at the second ends 312b, 322b thereof are sequentially the second polarity (−), the first polarity (+), the first polarity (+) and the second polarity (−). It should be noted that, in a pair of differential signals, the positive signal and the negative signal are performed process and analysis as a whole by the subsequent processor, without analyzing and processing the positive signal and the negative signal in isolation. Thus, even though the locations of the positive signal and the negative signal being transmitted by the first cable set 3a in the present embodiment are switched, the processing and analyzing of the whole pair of differential signals by the subsequent processor are not affected, as long as the processor may receive the pair of differential signals at the corresponding two ports.

In the technical aspects of the present invention, by providing the polarity arrangements of one pair of the first cable core 312 and the second cable core 322 at two ends thereof to be opposite to each other, while the polarity arrangements of the other pair of the first cable core 312 and the second cable core 322 at the two ends thereof remain unchanged, the FEXT generated from one of the cable sets 3 at the first end 312a, 322a thereof toward the other of the cable sets 3 at the second end 312b, 322b thereof and the FEXT generated from the one of the cable sets 3 at the second end 312b, 322b thereof toward the other of the cable sets 3 the first end 312a, 322a thereof are overlapped and thus are canceled, thereby reducing the overall FEXT in the overall path formed by the first connecting member 1, the cable sets 3 and the second connecting member 2, thus reducing the mutual crosstalk between the first connecting member 1 and the second connecting member 2, and reducing the FEXT of the electrical connecting assembly 100. In the present embodiment, each cable set 3 includes the shielding layer 34, which may shield the interference to the cable set 3 from the outer environment, such that the FEXT does not overlap and increase in the regions of each cable set 3 being wrapped by the shielding layer 34, thus further reducing the overall FEXT to the electrical connecting assembly 100.

Referring to FIG. 4 and FIG. 5, the first cable core 312 and the second cable core 322 of the first cable set 3a are isolated from each other by the first insulating material 311 and the second insulating material 321, and the first insulating material 311 and the second insulating material 321 tightly abut each other to maintain a constant isolation distance therebetween. Thus, even though the relative physical locations of the first cable core 312 and the second cable core 322 of the first cable set 3a are switched, the distance between the first cable core 312 and the second cable core 322 remains unchanged, such that the coupling effect of the first cable core 312 and the second cable core 322 at different locations thereof is relatively uniform, thus facilitating the transmission of the differential signals. Further, in the present embodiment, the relative physical locations of the first cable core 312 and the second cable core 322 of the second cable set 3b maintain unchanged in a transmission path thereof, that is, the relative physical locations of the first cable core 312 and the second cable core 322 of the second cable set 3b are not switched in the whole transmission path thereof. In other embodiments, the relative physical locations of the first cable core 312 and the second cable core 322 of the second cable set 3b may be switched multiple times, and the polarity arrangements at the first ends 312a, 322a thereof and at the second ends 312b, 322b thereof maintain identical to each other. For example, the relative physical locations of the first cable core 312 and the second cable core 322 of the second cable set 3b may be switched by an even number of times. In other words, the present invention does not require the relative physical locations of the first cable core 312 and the second cable core 322 of the second cable set 3b not to be switched. It should be noted that, compared to the case where the relative physical locations of the first cable core 312 and the second cable core 322 of the second cable set 3b are switched, in the present embodiment, by maintaining the polarity arrangements of the first cable core 312 and the second cable core 322 of the second cable set 3b unchanged in the whole transmission path thereof, it may be ensured that more FEXT are in opposite phases and in consistent amplitude, thus canceling more FEXT, such that less FEXT is finally applied to the electrical connecting assembly 100. In the present embodiment, when the first cable set 3a is not yet twisted, the first cable core 312 and the second cable core 322 thereof may be parallel double wires of the first cable set 3a, that is, the first cable core 312 and the second cable core 322 are provided in parallel. When the first cable set 3a is not yet twisted, the first cable core 312 and the second cable core 322 thereof may be twisted double wires of the first cable set 3a.

Referring to FIG. 1 and FIG. 5, in an extending length of the first cable set 3a, a twisting section Q2 is selected to be twisted, thus facilitating the switching of the relative physical locations of the first cable core 312 and the second cable core 322, and the maintaining sections located at two sides of the twisting section are not twisted. Thus, the relative physical locations of the first cable core 312 and the second cable core 322 of the first cable set 3a in each maintaining section Q1 maintain unchanged, and the relative physical locations of the first cable core 312 and the second cable core 322 of the first cable set 3a in the twisting section Q2 are switched. For better observation and understanding purposes, as shown in FIG. 5, a base line L1 and a base line L2 are respectively defined on the surfaces of the first cable set 3a and the second cable set 3b, and the base lines L1, L2 correspondingly extend along the length directions of the first cable set 3a and the second cable set 3b. When the first cable set 3a is not twisted, the relative location of the base line L1 in the first cable set 3a and the relative location of the base line L2 in the second cable set 3b are identical. It is shown in FIG. 5 that the base line L1 maintains extending in a straight line in the maintaining section Q1 at one side of the first cable set 3a, and the base line L1 is gradually twisted for 180 degrees in the twisting section Q2, such that the polarity arrangements of the first cable core 312 and the second cable core 322 in the two maintaining sections Q1 at the two ends of the twisting section Q2 are opposite to each other. Further, the second cable set 3b is not twisted, and the base line L2 maintains extending in a straight line in the whole length thereof. It should be noted that, in the present embodiment, the twisting section Q2 is located at a middle portion of the first cable set 3a, and the two maintaining sections Q1 are located at the two sides of the twisting section Q2. In other embodiments, the locations and quantities of the maintaining section Q1 and the twisting section Q2 may be provided based on actual needs, and thus are not hereinafter limited thereto.

In other embodiments, the first cable set 3a may be suddenly twisted acutely at a certain location thereof, or may be twisted gradually in the whole length of the first cable set 3a, without being limited thereto. To facilitate the acute twisting at a certain location of the first cable set 3a, the stress of material characteristics of the first cable set 3a may be utilized to maintain the twisting status. Alternatively, the twisting status may be maintained by adding a fixing member, for example, an adhesive tape may function as the fixing member, and the adhesive tape is wrapped at the twisting location, or an insert-molding member may function as the fixing member, and the insert-molding member is wrapped and fixed at the twisting location, without being limited thereto. Similarly, the fixing member such as the adhesive tape or the insert-molding member may be used to maintain the twisting status of the twisting section Q2 of the first cable set 3a in the first embodiment.

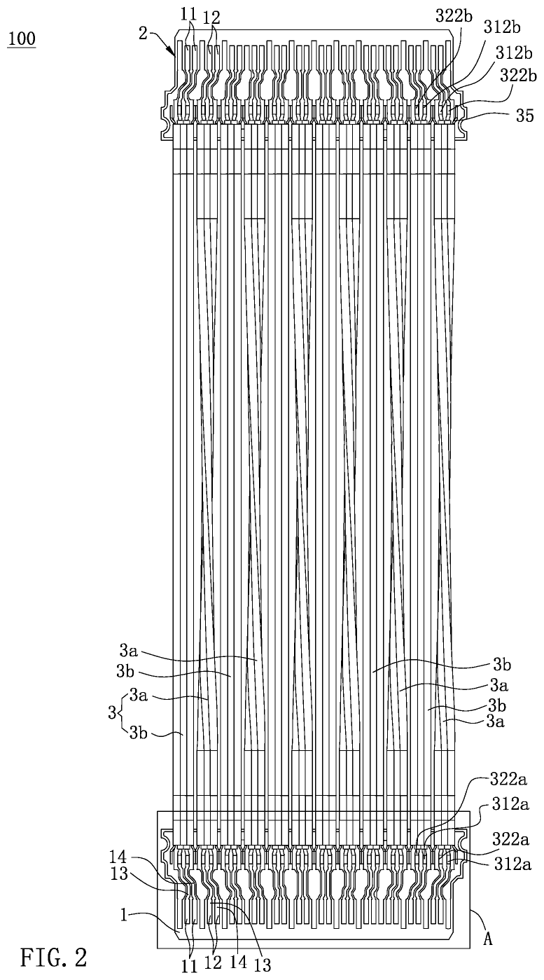

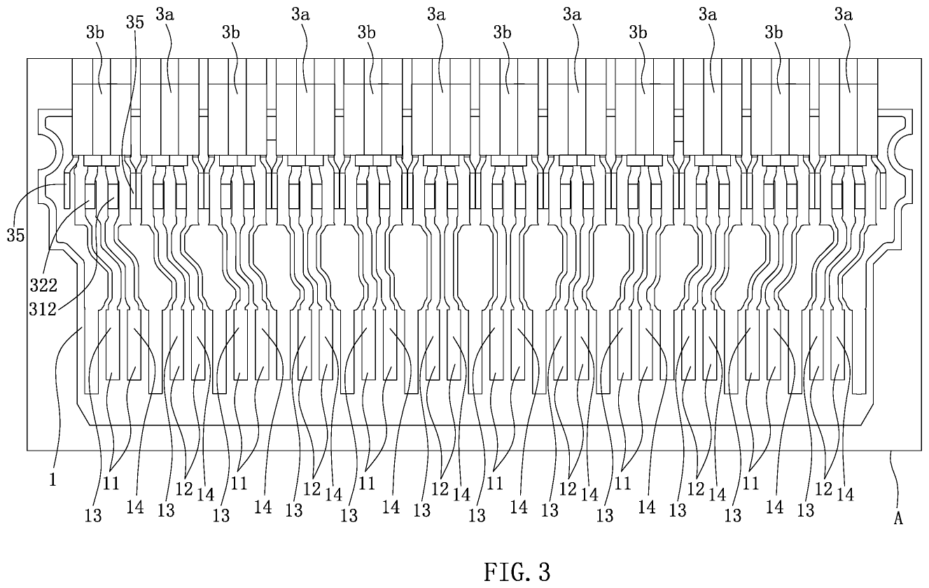

Referring to FIG. 2 and FIG. 3, the first connecting member 1 is a circuit board. The circuit board includes a plurality of pairs of differential signal channels. The pairs of differential signal channels have two pairs of differential signal channels provided to be adjacent to each other and used to be connected to the first cable set 3a and the second cable set 3b respectively. Each pair of the differential signal channels includes a first channel 13 and a second channel 14 respectively connected to the first cable core 312 and the second cable core 322 correspondingly. The first connecting member 1 further has a plurality of grounding channels used to be connected to the grounding wires 35 of the corresponding cable sets 3 respectively. In the present embodiment, relative physical locations of the first channel 13 and the second channel 14 of each pair of the differential signal channels of the first connecting member 1 maintain unchanged. In the present embodiment, the second connecting member 2 is also a circuit board, and the channel design thereof may refer to the channel design of the first connecting member 1 as shown in FIG. 3, or may be designed to be other structures according to actual needs.

It should be noted that, if twisting 180 degrees serves as twisting once, to facilitate the polarity arrangements of the first cable cores 312 and the second cable cores 322 of the first cable set 3a and the second cable set 3b at the first ends 312a, 322a thereof and the polarity arrangements at the second ends thereof to be provided opposite to each other, the number of twisting of the first cable set 3a is an odd number. In addition, to reduce the shape change of the first cable set 3a as much as possible, the number of twisting may be reduced.

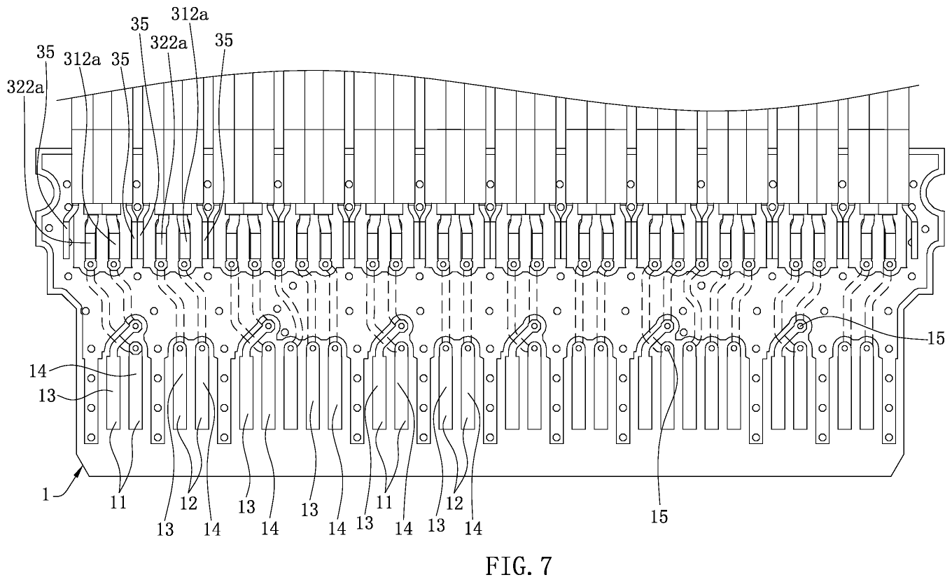

Referring to FIG. 7, which shows a second embodiment of the present embodiment, which is different from the first embodiment in that the channel design of the first connecting member 1 is different. Specifically, in the second embodiment, the first connecting member 1 is a circuit board, and the first connecting member 1 has two pairs of differential signal channels provided to be adjacent to each other and used to be connected to the first cable set 3a and the second cable set 3b respectively, that is, a first pair of the differential signal channels 11 and a second pair of the differential signal channels 12. Each pair of the differential signal channels includes a first channel 13 and a second channel 14 respectively connected to a corresponding pair of the first cable core 312 and the second cable core 322. Relative physical locations of the first channel 13 and the second channel 14 of the first pair of the differential signal channels 11 are switched in a transmission path thereof to switch polarity arrangements of the first channel 13 and the second channel 14. Relative physical locations of the first channel 13 and the second channel 14 of the second pair of the differential signal channels 12 maintain unchanged in a transmission path thereof. Thus, in the second embodiment, in addition to performing polarity exchange to the first cable core 312 and the second cable core 322 of the first cable set 3a, there is further the polarity exchange to the first channel 13 and the second channel 14 of the first pair of the differential signal channels 11 of the first connecting member 1, thus reducing the FEXT between the two pairs of the differential signal channels provided to be adjacent to each other in the first connecting member 1, such that the electrical connecting assembly 100 may reduce the FEXT in the longer signal transmission path thereof. Further, in the second embodiment, the second connecting member 2 is also a circuit board, and the channel design thereof may refer to the channel design of the first connecting member 1 as shown in FIG. 7, thus reducing the FEXT between the two pairs of the differential signal channels provided to be adjacent to each other in the first connecting member 1, reducing the FEXT between the first cable set 3a and the second cable set 3b provided to be adjacent to each other, and reducing the FEXT between the two pairs of the differential signal channels provided to be adjacent to each other in the second connecting member 2, such that the FEXT in different sections of the transmission path of the electrical connecting assembly 100 may all be reduced. To facilitate the switching of the relative physical locations of the first channel 13 and the second channel 14 of one pair of the differential signal channels in the transmission path thereof, the first channel 13 and the second channel 14 may be formed through the through holes 15 such that the first channel 13 is arranged in two layers of coating layers, and the second channel 14 is arranged in two layers of coating layers, thus preventing the first channel 13 and the second channel 14 from being in contact with each other.

It should be noted that, in other embodiments, when the first connecting member 1 and the second connecting member 2 are both circuit boards, it is possible to select only one of the first connecting member 1 and the second connecting member 2 to be provided with the first channel 13 and the second channel 14 with the polarity exchange, without requiring the first connecting member 1 and the second connecting member 2 to have the same configuration. It should be noted that the electrical connecting assembly 100 may have the one pair of the differential signal channels with the polarity exchange to be connected to the first cable set 3a with the polarity exchange, and the other pair of the differential signal channels without the polarity exchange to be connected to the second cable set 3b without the polarity exchange. Alternatively, it may be the one pair of the differential signal channels with the polarity exchange to be connected to the second cable set 3b, and the other pair of the differential signal channels without the polarity exchange to be connected to the first cable set 3a with the polarity exchange. The technicians may freely match and combine the components according to the actual need, without being limited hereinafter thereto.

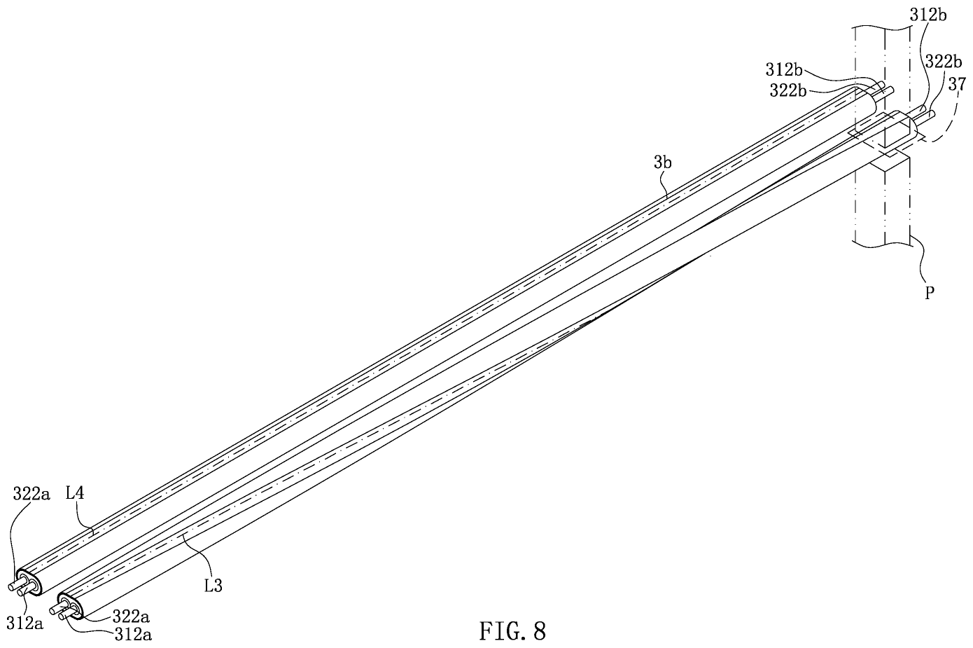

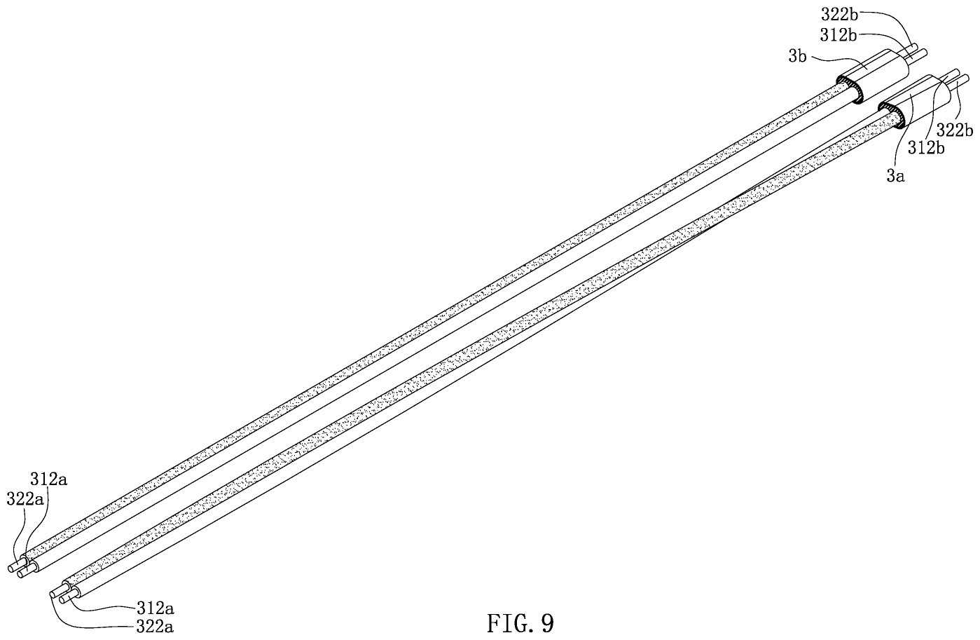

Referring to FIG. 8 and FIG. 9, which shows a third embodiment of the present embodiment. The third embodiment is different from the first embodiment in that: the first cable set 3a is provided with a positioning portion 37, and the positioning portion 37 is located on the first cable set 3a at a location adjacent to the second ends 312b, 322b thereof, allowing an operation body P to drive the positioning portion 37 to twist the first cable set 3a when the first ends 312a, 322a thereof is relatively fixed. It should be noted that, since the first cable set 3a facilitates the twisting by relatively fixing the first ends 312a, 322a thereof and driving the second ends 312b, 322b thereof by the operation body, thus allowing the first cable set 3a to twist as a whole, and facilitating the gradually change of the twisting angle of the first cable set 3a in the length direction of the first cable set 3a, such that the polarity arrangements of the first cable core 312 and the second cable core 322 of the first cable set 3a at the first ends 312a, 322a thereof and at the second ends 312b, 322b thereof are provided to be opposite to each other, without being twisted acutely at a certain location thereof. The operation body P may be the hand of an operational person, or may be a mechanical tool, etc. For better observation and understanding purposes, as shown in FIG. 8, a base line L3 and a base line L4 are respectively defined on the surfaces of the first cable set 3a and the second cable set 3b, and the base lines L3, L4 correspondingly extend along the length directions of the first cable set 3a and the second cable set 3b. When the first cable set 3a is not twisted, the relative location of the base line L3 in the first cable set 3a and the relative location of the base line L2 in the second cable set 3b are identical. It is shown in FIG. 8 that the base line L3 of the first cable set 3a gradually twists for 180 degrees in the whole length thereof, such that the polarity arrangements of the first cable core 312 and the second cable core 322 at the first ends 312a, 322a of the first cable set 3a and at the second ends 312b, 322b of the first cable set 3a are opposite to each other. Further, the second cable set 3b is not twisted, and the base line L4 maintains extending in a straight line in the whole length thereof. If the first cable set 3a is twisted acutely at a certain location thereof to facilitate the opposite polarity arrangements at the first ends 312a, 322a thereof and at the second ends 312b, 322b thereof, the first cable core 312 and the second cable core 322 may have relatively large sudden changes in their shapes, and the differential signals will generate a huge amount of signal reflections at the location of the shape change, thus resulting in a large signal loss. Further, the acute twisting will cause a stronger compressive force to the insulating material between the first cable core 312 and the second cable core 322, such that the insulating material deforms to make it difficult to maintain a constant distance between the first cable core 312 and the second cable core 322 in the transmission path thereof, which is not conducive to the transmission of the differential signals. Compared to either the acute twisting implementation or the implementation of selecting a portion thereof as the twisting section Q2 as described in the first embodiment, in the present embodiment, the first cable set 3a may gradually twist in the whole length thereof, and the twisting angle in a unit length is relatively smaller, such that the first cable core 312 and the second cable core 322 have slower changes in their shapes thereof, thus reducing the signal reflections caused by the sudden shape changes, and further reducing the signal loss, which is conducive to the transmission of the differential signals. Further, the first cable set 3a basically extends in a straight line in the whole length thereof, which does not require the length of the first cable set 3a in its extending direction to excessively compensate the width direction thereof to facilitate rapid twisting, thus preventing the first cable set 3a from having a shorter distance from the first ends 312a, 322a thereof toward the second ends 312b, 322b thereof after being twisted that results in difficulties to connect the first cable set 3a to the first connecting member 1 or the second connecting member 2. In the present embodiment, the first cable set 3a is twisted only once, and as shown in FIG. 8, the first cable set 3a substantially extends in a straight line as a whole. Further, compared to the case where the first cable set 3a has not yet been twisted, the change to the extending length of the first cable set 3a is small, and the first cable core 312 and the second cable core 322 do not have locations with great distortion and deformation.

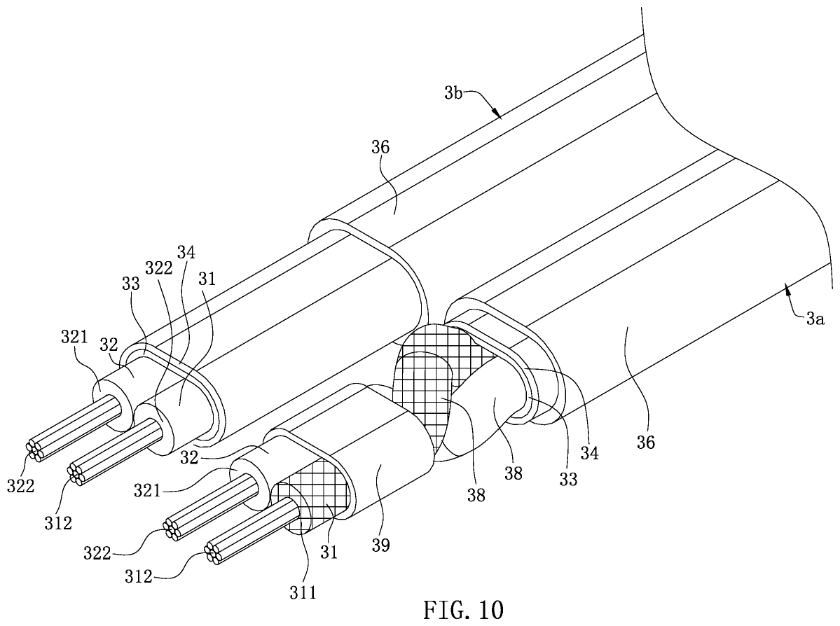

Referring to FIG. 10, which shows a fourth embodiment of the present embodiment. The fourth embodiment is different from the first embodiment in that: each of the first conducting wire 31 and the second conducting wire 32 is provided with an exposed portion 38 at a location adjacent to the first ends 312a, 322a thereof or the second end 312b, 322b thereof. The exposed portion 38 is located outside the shielding layer 34, and the exposed portion 38 of the first conducting wire 31 and the exposed portion 38 of the second conducting wire 32 cross each other, such that the relative physical locations of the first cable core 312 and the second cable core 322 are switched. Compared to the first embodiment and the third embodiment, in which the switching and twisting occur in a relatively longer area, which is inconvenient for observation of the number of switching, in the present embodiment, the location of the polarity exchange is provided at the exposed portion 38, which is adjacent to the first ends 312a, 322a thereof or the second ends 312b, 322b thereof, thereby allowing the staff to observe and check the number of switching of the relative physical locations of the first cable core 312 and the second cable core 322, thus preventing the relative physical locations of the first cable core 312 and the second cable core 322 from being switched an even number of times that results in the polarity arrangements of the first cable set 3a and the second cable set 3b at the first ends 312a, 322a thereof and at the second ends 312b, 322b thereof not being opposite to each other. Further, to maintain the switching of the relative physical locations of the first conducting wire 31 and the second conducting wire 32, in the present embodiment, a fixing sleeve 39 is provided to sleeved outside the exposed portion 38. In other embodiments, it is possible not to provide the fixing sleeve 39, and in the processing of connecting the first ends 312a, 322a or the second ends 312b, 322b to the first connecting member 1 or the second connecting member 2, the technicians may simultaneously exchange the locations of the first cable core 312 and the second cable core 322. In the fourth embodiment, the first conducting wire 31 has a plurality of coaxial cable cores that collectively form the first cable core 312, and the second conducting wire 32 has a plurality of coaxial cable cores that collectively form the second cable core 322.

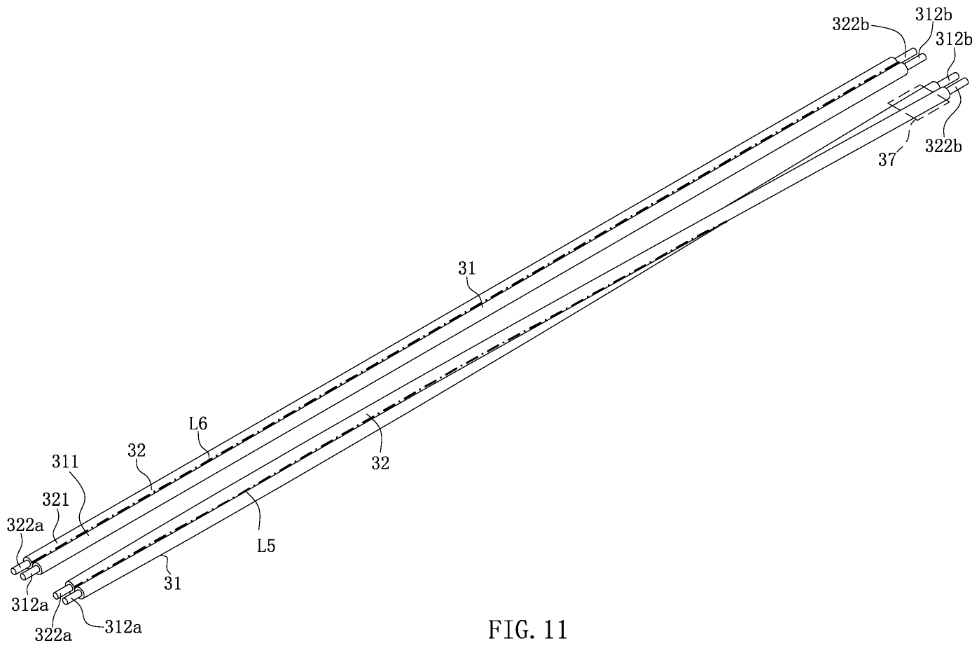

Referring to FIG. 11, which shows a fifth embodiment of the present embodiment, which is different from the first embodiment in that: there is no third insulating material 33, shielding layer 34 and protecting sleeve 36, etc., being provided outside the first conducting wire 31 and outside the second conducting wire 32. That is, the electrical connecting assembly 100 in the fifth embodiment includes a first connecting member 1, a second connecting member 2 and a plurality of conducting wires connected between the first connecting member 1 and the second connecting member 2, and the conducting wires includes two pairs of differential conducting wires provided to be adjacent to each other. Each pair of the differential conducting wires includes a first conducting wire 31 and a second conducting wire 32 provided to be adjacent to each other and used to transmit the differential signals. The first conducting wire 31 includes a first cable core 312 used to transmit the signals in a first polarity and a first insulating material 311 wrapping outside the first cable core 312, and the second conducting wire 32 includes a second cable core 322 used to transmit the signals in a second polarity and a second insulating material 321 wrapping outside the second cable core 322.

In the fifth embodiment, for the two pairs of the differential conducting wires provided to be adjacent to each other (that is, the first pair of the differential conducting wires and the second pair of the differential conducting wires), the polarity arrangements of the first cable core 312 and the second cable core 322 of the first pair of the differential conducting wires at the first ends 312a, 322a thereof and the polarity arrangements of the first cable core 312 and the second cable core 322 of the first pair of the differential conducting wires at the second ends 312b, 322b thereof are provided to be opposite to each other, and the polarity arrangements of the first cable core 312 and the second cable core 322 of the second pair of the differential conducting wires at the first ends 312a, 322a thereof and the polarity arrangements of the first cable core 312 and the second cable core 322 of the second pair of the differential conducting wires at the second ends 312b, 322b thereof are identical to each other. Even though the two pairs of the differential conducting wires do not have the shield layer 34, thus allowing the first cable cores 312 and the second cable cores 322 to be subject to the FEXT in the transmission paths thereof from the first connecting member 1 or the second connecting member 2, the first cable core 312 and the second cable core 322 of the first pair of the differential conducting wire have polarity exchange, thus allowing the FEXT to have portions thereof being overlapped and then canceled, and thereby reducing the overall FEXT to the electrical connecting assembly 100. Further, similarly to the previous embodiments, a base line L5 and a base line L6 are respectively defined on the surfaces of the first pair of the differential conducting wires and the second pair of the differential conducting wires, and the base lines L5, L6 correspondingly extend along the length directions of the first pair of the differential conducting wires and the second pair of the differential conducting wires. When the first pair of the differential conducting wires are not twisted, the relative location of the base line L1 in the first pair of the differential conducting wires and the relative location of the base line L2 in the second pair of the differential conducting wires are identical. It is shown that the base line L5 of the first pair of the differential conducting wires gradually twists for 180 degrees in the whole length thereof, such that the polarity arrangements of the first cable core 312 and the second cable core 322 at the first ends 312a, 322a of the first pair of the differential conducting wires and at the second ends 312b, 322b of the first pair of the differential conducting wires are opposite to each other. Further, the second pair of the differential conducting wires are not twisted, and the base line L6 maintains extending in a straight line in the whole length thereof.

Further, a positioning portion 37 is provided in the first pair of the differential conducting wires, and the positioning portion 37 is located on the first pair of the differential conducting wires at a location adjacent to the second ends 312b, 322b thereof, allowing an operation body P to drive the positioning portion 37 to twist the first pair of the differential conducting wires when the first ends 312a, 322a thereof is relatively fixed, such that the polarity arrangements of the first cable core 312 and the second cable core 322 of the first pair of the differential conducting wires at the first ends 312a, 322a thereof and the polarity arrangements at the second ends 312b, 322b thereof are provided to be opposite to each other. The positioning portion 37 of the first pair of the differential conducting wires may be provided on each of the first conducting wire 31 and the second conducting wire 32, or may be provided only on one of the first conducting wire 31 and the second conducting wire 32, thus preventing the first pair of the differential conducting wires from having acute twisting, and reducing the signal reflections caused by the sudden shape changes of the first pair of the differential conducting wires. Further, the first pair of the differential conducting wires, being driven by the operation body P, is only twisted once, and the first cable core 312 and the second cable core 322 extend in a straight line as a whole, thus further reducing the twisting angle in a unit length of the first pair of the differential conducting wires, and reducing the change in the shapes of the first pair of the differential conducting wires.

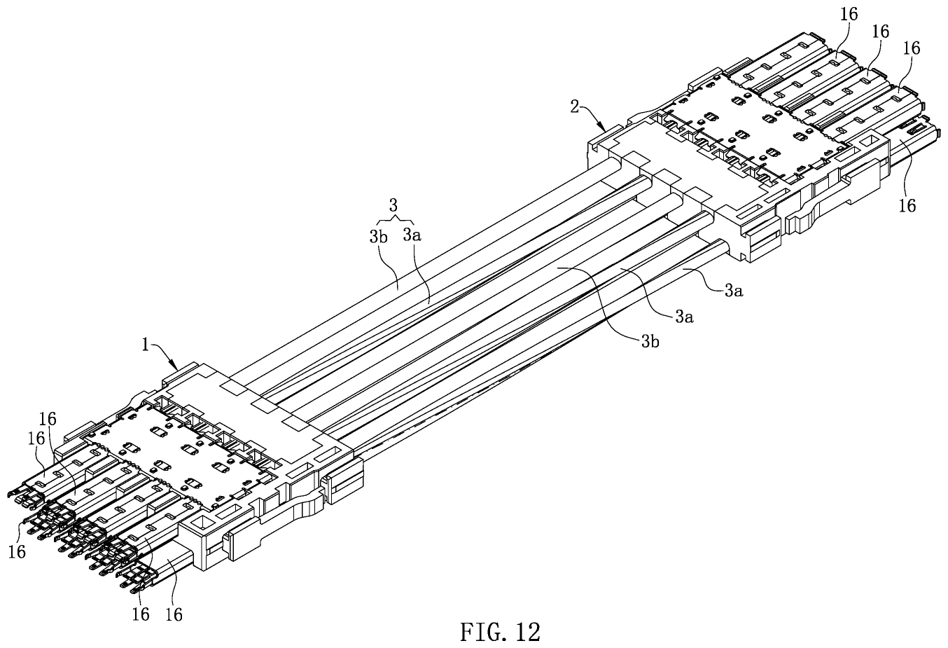

Referring to FIG. 12, which shows a sixth embodiment of the present embodiment. The sixth embodiment is different from the first embodiment in that the first connecting member 1 and the second connecting member 2 are not circuit boards, and instead, the first connecting member 1 includes at least one electrical module, the second connecting member 2 includes at least one electrical module, and each electrical module has a plurality of terminal modules 16. When a plurality of electrical modules are sequentially arranged, they may form a backplate connector. The first connecting member 1 and the second connecting member 2 are both provided with a plurality of terminal modules 16. Each terminal module 16 includes a pair of differential terminals, and each pair of the differential terminals are connected to the first cable core 312 and the second cable core 322 of a corresponding cable set 3. In other embodiments, the first connecting member 1 and the second connecting member 2 may be a backplate connector in another form or a connector in another type, without being hereinafter limited thereto.

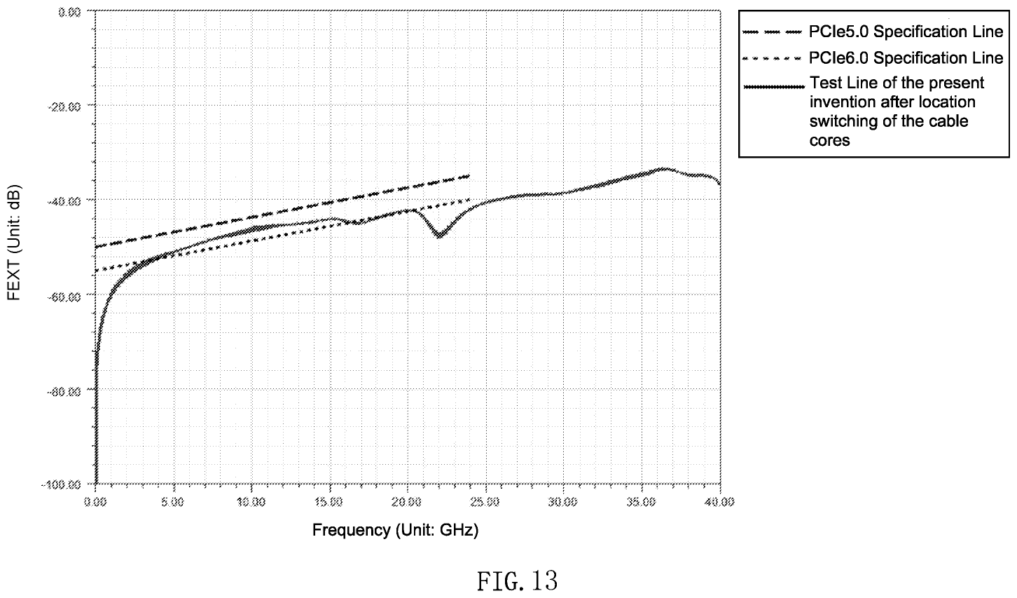

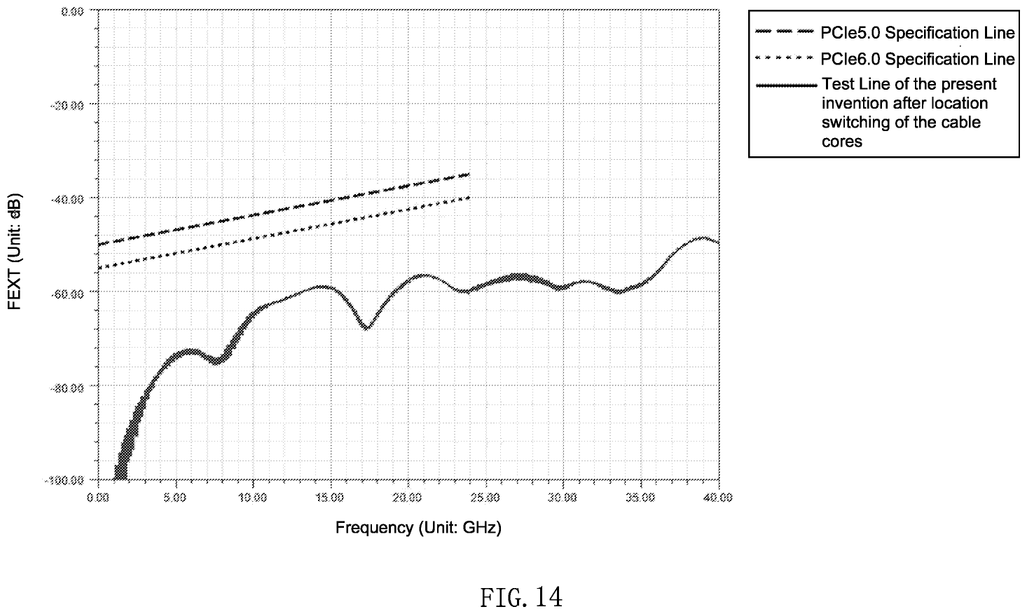

To better understand the technical effects that may be achieved by the technical solutions of the present invention, referring to FIG. 13 and FIG. 14, which respectively show the simulation test charts prior to and after switching of the relative physical locations of the first cable core 312 and the second cable core 322 of the first cable set 3aof the electrical connecting assembly 100. In FIG. 13 and FIG. 14, the horizontal coordinate refers to the frequency, and the vertical coordinate refers to the FEXT. As shown in FIG. 13, prior to the switching, although the FEXT characteristics of the electrical connecting assembly 100 satisfy the PCIe 5.0 Specification, the test line is very close to the PCIe 5.0 Specification line, and once the electrically connecting assembly 100 is in actual use in an poor surrounding environment, it is possible that it fails to meet the PCIe 5.0 Specification. In addition, when the frequency is greater than 3 GHz, the FEXT characteristics of the electrically connecting assembly 100 do not satisfy the PCIe 6.0 Specification, which makes it difficult to apply to high frequency transmission scenarios. As shown in FIG. 14, after applying the technical solution of the present invention, the FEXT characteristics of the electrical connecting assembly 100 may simultaneously satisfy the PCIe 5.0 Specification and the PCIe 6.0 Specification, and may be far superior to the PCIe 5.0 Specification and the PCIe 6.0 Specification. Even though the electrically connecting assembly 100 is in actual use in an poor surrounding environment, it is ensured that the FEXT characteristics of the electrical connecting assembly 100 satisfy the PCIe 5.0 Specification and the PCIe 6.0 Specification. In particular, in the high frequency, the FEXT characteristics of the electrical connecting assembly 100 may also perform well. In addition, comparing FIG. 13 and FIG. 14, when the frequency is at 10 GHz, after applying the technical solution of the present invention, the FEXT may be reduced from substantially −46 dB to substantially −65 dB. When the frequency is at 20 GHz, after applying the technical solution of the present invention, the FEXT may be reduced from substantially −43 dB to substantially −68 dB. When the frequency is at 30 GHz, after applying the technical solution of the present invention, the FEXT may be reduced from substantially −38 dB to substantially −59 dB. Thus, the technical solution of the present invention may greatly reduce the FEXT to the electrically connecting assembly 100.

It should be noted that, if the polarity exchange is achieved by having the differential terminals crossing each other, the pair of the differential terminals crossing each other in this technical solution must occupy a larger space in their height direction and width direction in order to prevent the two terminals of the pair of the differential terminals from being in contact with each other, and in particular, the connector itself is a relatively smaller component, and the space occupied greatly affects the space layout of the connector. Further, since the terminals are rigid, in order to have the two terminals crossing each other, a portion of one of the terminals must bend and extend obliquely toward the other terminal, thus increasing the forming difficulties of the terminals. Meanwhile, the portion extending obliquely will increase the transmission path of the terminal, such that the pair of the differential terminals crossing each other have a longer transmission path in comparison to another pair of the differential terminals not crossing each other, further resulting in a greater transmission time delay between different pairs of the differential terminals, and affecting the signal transmission of the connector. In particular, for signals that require high speed transmission, the requirement for the transmission time delay between different pairs of the differential terminals in the connector is stricter, and adding a small time difference may make the processor unable to process the signal correctly. In addition, in order to reduce the transmission time delay between different pairs of the differential terminals, the lengths of the terminals in the other pair of the differential terminals not crossing each other must be extended correspondingly, such as increasing a bending section thereof, which may also increase the forming difficulties of the terminals. Meanwhile, since the two pairs of the differential terminals both increase the bending shapes, the impedances of the terminals at the bending locations will increase, which creates a challenge to the consistency of the impedances of the differential terminals in the connector. Thus, it can be seen that this technical solution reduces the FEXT between the two pairs of the differential terminals in the connector, and greatly affects the forming difficulties of the terminals of the connector, the space layout inside the connector, the impedances of the terminals, and the transmission time delay between different pairs of the differential terminals, thus excessively increasing the design difficulties of the connector. However, the technical solution of the present invention may perform switching to the relative physical locations of the first cable core 312 and the second cable core 322 of one pair of the two adjacent pairs of the differential signal conducting wires or two pairs of the cable sets 3, which are connected to the first connecting member 1 and the second connecting member 2, thus reducing the FEXT between the first connecting member 1 and the second connecting member 2, and achieving the reducing of the FEXT without affecting the space layout in the first connecting member 1 and the second connecting member 2. The flexibility characteristics of the cable sets 3 or the conducting wires may be utilized to facilitate polarity exchange, thus greatly simplifying the manufacturing process. In addition, the technical solution of the present invention may be facilitate under the condition that the lengths of different pairs of the first cable cores 312 and the second cable cores 322 are consistent, thus preventing from a large transmission time difference between different pairs of the differential signals. Meanwhile, since insulating materials are provided outside the first cable core 312 and outside the second cable core 322 to perform isolation, the switching of the relative physical locations of the first cable core 312 and the second cable core 322 may be facilitated without adding additional space.

In addition, if signal interconnection between the first connecting member 1 and the second connecting member 1 is facilitated by an intermediate circuit board, and the intermediate circuit board is provided with the channel design similar to that as shown in FIG. 7 to reduce the FEXT between the first connecting member 1 and the second connecting member 1, this technical solution also has the deficiencies of the aforementioned technical solution to have two terminals crossing each other to reduce the FEXT. In addition, this technical solution requires special channel design for intermediate circuit boards with different sizes, and in the differential signal channels of the intermediate circuit board, it is required to have two layers of coating layers to facilitate polarity exchange, and it is required to increase the through holes to perform the interlayer design, thus occupying the internal space of the intermediate circuit board, increasing the design difficulties of the intermediate circuit board, and increasing the manufacturing process and manufacturing cost of the intermediate circuit board. In particular, for designing and manufacturing the intermediate circuit board having a plurality of layers of plates, the design difficulties, manufacturing difficulties and manufacturing cost are all very high. Compared to this technical solution, the present invention utilizes the cable sets 3 or the conducting wires originally used for connecting functions to reduce the FEXT, and the cable sets 3 or the conducting wires located between the first connecting member 1 and the second connecting member 2 may be flexibly placed in the space, which may be directly used in the electrical connecting assemblies 100 of different length specifications, thus having little effects on the space layout and arrangement of the conducting wires or the cable sets 3, and the original flexibility characteristics of the cable sets 3 or the conducting wires may be utilized to facilitate switching of the relative physical locations of the corresponding pair of the first cable core 312 and the second cable core 322. The technical solution of the present invention is easy for implementation and application, and has little effect to the design difficulties and manufacturing cost of the electrical connecting assembly 100.

In addition, in the case where the intermediate circuit board is used, considering the spacing between the two signal channels in one pair of the differential signal channels and the process accuracy thereof, a distance between the two signal channels is at least 0.4 mm. In comparison, since the insulating material exists between the first cable core 312 and the second cable core 322 in the pair of the differential conducting wires, the spacing may be 0.25 mm. Thus, compared to the case where the FEXT between the first connecting member 1 and the second connecting member 2 is reduced by the intermediate circuit board, the technical solution according to certain embodiments of the present invention may relatively reduce the distance between the differential signal terminals, which is conducive to the mutual coupling and transmission of the differential signals.

In sum, the electrical connecting assembly 100 according to certain embodiments of the present invention has the following beneficial effects:

1. Reducing the FEXT of the electrical connecting assembly 100, and in particular, the FEXT characteristics in high frequency thereof will be in excellent performance. Meanwhile, the flexibility characteristics of the first cable core 312 and the second cable core 322 may be utilized to facilitate polarity exchange, thus greatly simplifying the manufacturing process, without affecting the design difficulties and forming difficulties of the first connecting member 1 and the second connecting member 2.

2. The first connecting member 1 is a circuit board, and relative physical locations of the first channel 13 and the second channel 14 of one pair of the differential signal channels are switched in a transmission path thereof to switch polarity arrangements of the first channel 13 and the second channel 14, thus reducing the FEXT between the two pairs of the differential signals provided to be adjacent to each other in the first connecting member 1, such that the electrical connecting assembly 100 may reduce the FEXT in a longer signal transmission path thereof.

3. The first cable set 3a facilitates the twisting by relatively fixing the first ends 312a, 322a thereof and driving the second ends 312b, 322b thereof by the operation body P, thus allowing the first cable set 3a to twist as a whole, and facilitating the gradually change of the twisting angle of the first cable set 3a in the length direction of the first cable set 3a, such that the first cable core 312 and the second cable core 322 have slower changes in their shapes thereof, thus reducing the signal reflections caused by the sudden shape changes, and further reducing the signal loss, which is conducive to the transmission of the differential signals.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connecting assembly, comprising:
a first connecting member;
a second connecting member; and
two cable sets provided to be adjacent to each other, comprising a first cable set and a second cable set, connected between the first connecting member and the second connecting member, wherein each of the cable sets comprises a first cable core and a second cable core provided in a pair and configured to transmit differential signals, and a shielding layer surrounding outer peripheries of the first cable core and the second cable core, the first cable core, the second cable core and the shielding layer are electrically isolated from one another, the first cable core is configured to transmit signals in a first polarity, the second cable core is configured to transmit signals in a second polarity, and the first polarity and the second polarity are opposite to each other;
wherein for each of the cable sets, a first end of the first cable core and a first end of the second cable core are provided to be adjacent to each other and are both connected to the first connecting member, and a second end of the first cable core and a second end of the second cable core are provided to be adjacent to each other and are both connected to the second connecting member;
wherein relative physical locations of the first cable core and the second cable core of the first cable set are switched in a transmission path thereof, and polarity arrangements of the first cable core and the second cable core of the first cable set at the first ends thereof and at the second ends thereof are opposite to each other; and wherein polarity arrangements of the first cable core and the second cable core of the second cable set at the first ends thereof and at the second ends thereof are identical to each other;
wherein the polarity arrangements of the first cable cores and the second cable cores of the two cable sets at the first ends thereof are sequentially the first polarity, the second polarity, the first polarity and the second polarity, and the polarity arrangements of the first cable cores and the second cable cores of the two cable sets at the second ends thereof are sequentially the second polarity, the first polarity, the first polarity and the second polarity.

2. The electrical connecting assembly according to claim 1, wherein the first cable set comprises at least one insulating material wrapping outside the first cable core and outside the second cable core, the first cable core and the second cable core are isolated by the insulating material and maintain a constant isolation distance therebetween, and the shielding layer is located at an outer side of the insulating material; and
wherein relative physical locations of the first cable core and the second cable core of the second cable set maintain unchanged in a transmission path thereof.

3. The electrical connecting assembly according to claim 1, wherein the first cable set is provided with a positioning portion, and the positioning portion is located on the first cable set at a location adjacent to the second end thereof, allowing an operation body to drive the positioning portion to twist the first cable set when the first end thereof is relatively fixed.

4. The electrical connecting assembly according to claim 1, wherein the first cable set comprises a first insulating material wrapping outside the first cable core and a second insulating material wrapping outside the second cable core, the first cable core and the first insulating material form a first conducting wire, the second cable core and the second insulating material form a second conducting wire, the shielding layer wraps outer sides of the first conducting wire and the second conducting wire, each of the first conducting wire and the second conducting wire is provided with an exposed portion at a location adjacent to the first end thereof or the second end thereof, the exposed portion is located outside the shielding layer, and the exposed portion of the first conducting wire and the exposed portion of the second conducting wire cross each other, such that the relative physical locations of the first cable core and the second cable core of the first cable set are switched.

5. The electrical connecting assembly according to claim 1, wherein the first connecting member is a circuit board, the circuit board has two pairs of differential signal channels configured to be connected to the two cable sets respectively, and each pair of the two pairs of differential signal channels comprises a first channel and a second channel; and
wherein relative physical locations of the first channel and the second channel of one pair of the two pairs of differential signal channels are switched in a transmission path thereof to switch polarity arrangements of the first channel and the second channel; and relative physical locations of the first channel and the second channel of the other pair of the two pairs of differential signal channels maintain unchanged in a transmission path thereof.

6. The electrical connecting assembly according to claim 1, wherein the first cable set is provided with at least one maintaining section and at least one twisting section, the relative physical locations of the first cable core and the second cable core of the first cable set in the maintaining section maintain unchanged, and the relative physical locations of the first cable core and the second cable core of the first cable set in the twisting section are switched.

7. An electrical connecting assembly, comprising:
a first connecting member;
a second connecting member; and
two pairs of differential conducting wires provided to be adjacent to each other, comprising a first pair of differential conducting wires and a second pair of differential conducting wires, connected between the first connecting member and the second connecting member, wherein each pair of the two pairs of differential conducting wires comprises a first cable core and a second cable core provided to be adjacent to each other, the first cable core is configured to transmit signals in a first polarity, the second cable core is configured to transmit signals in a second polarity, and the first polarity and the second polarity are opposite to each other;
wherein polarity arrangements of the first cable core and the second cable core of the first pair of differential conducting wires at a first end thereof and at a second end thereof are opposite to each other; and wherein polarity arrangements of the first cable core and the second cable core of the second pair of differential conducting wires at a first end thereof and at a second end thereof are identical to each other.

8. The electrical connecting assembly according to claim 7, wherein relative physical locations of the first cable core and the second cable core of the second pair of differential conducting wires maintain unchanged in a transmission path thereof.

9. The electrical connecting assembly according to claim 7, wherein the first connecting member is a circuit board, the circuit board has two pairs of differential signal channels configured to be connected to the two pairs of differential conducting wires respectively, and each pair of the two pairs of differential signal channels comprises a first channel and a second channel respectively connected to the first cable core and the second cable core of a corresponding pair of the two pairs of differential conducting wires; and
wherein relative physical locations of the first channel and the second channel of one pair of the two pairs of differential signal channels are switched in a transmission path thereof to switch polarity arrangements of the first channel and the second channel; and relative physical locations of the first channel and the second channel of the other pair of the two pairs of differential signal channels maintain unchanged in a transmission path thereof.

10. The electrical connecting assembly according to claim 7, wherein the first pair of differential conducting wires is provided with a positioning portion, the positioning portion is located on the first pair of differential conducting wires at a location adjacent to the second end thereof, allowing an operation body to be fixed relatively at the first end thereof to drive the positioning portion to twist the first pair of differential conducting wires, such that polarity arrangements of the first cable core and the second cable core of the first pair of differential conducting wires at the first end thereof and at the second end thereof are opposite to each other, and the first cable core and the second core of the first pair of differential conducting wires extend in a straight line as a whole.
